(19) United States
(12) Patent Application Publication
(10) Pub. No.: US 2014/0283757 A1
(43) Pub. Date: Sep. 25, 2014

(54) PET LASER TOY

(71) Applicant: Maze Innovations, Inc., Montreal, MO (US)

(72) Inventors: George McConnell Davison, III, Pittsburgh, PA (US); Peter Arthur Meier, Fenelton, PA (US); Jason Reed Rogge, Belle Vernon, PA (US); Colin Derek Curry, Allison Park, PA (US); Matthew David McClatchey, Harwick, PA (US)

(73) Assignee: Maze Innovations, Inc., Montreal, MO (US)

(21) Appl. No.: 14/218,187

(22) Filed: Mar. 18, 2014

Related U.S. Application Data
(60) Provisional application No. 61/804,875, filed on Mar. 25, 2013.

(51) Int. Cl. A01K 15/02

(52) U.S. Cl. CPC A01K 15/025; A01K 15/021
USPC 119/707

(57) ABSTRACT

The present inventive concepts relate to pet toys, in general, and specifically to pet toys constructed and adapted to provide a light source which directs a point of light on a distal surface to provide entertainment to an animal. A pet toy can include a housing suitable for attachment to mounting surface, such as ceiling or wall. The housing can further contain a laser light, a power supply, one or more motors and control circuitry. The motor(s) and control circuitry can be configured to move the light source to cause the point of light to move around on the distal surface. The control circuitry may be remotely operable via a remote control unit. The pet toy may selectively allow for either a constant or an intermittent display of the laser light, and may include a timing circuit to permit automatic deactivation of the light.

### PRIORITY CLAIM

This application is a nonprovisional of, and claims priority from, U.S. Provisional Patent App. Ser. No. 61/804,875 filed Mar. 25, 2013, the contents of which are hereby incorporated herein by reference in their entirety.

### BACKGROUND OF THE INVENTIVE CONCEPTS

The present inventive concepts generally relate to pet toys, and specifically, to pet toys constructed and adapted to direct a point of light on a distal surface to provide entertainment to the animal.

There are many varieties of pet toys. Many pet toys incorporate a bobble, dangle, or similar small item that is readily moved in an erratic fashion to attract and entertain the animal. Many such toys also incorporate a light, and may be capable of directing a small point of light at various objects to allow the animal to chase the spot of light. The industry, however, is in need of a pet toy that is capable of being mounted and which provides a moving light object to entertain a pet.

### BRIEF SUMMARY OF THE INVENTIVE CONCEPTS

It is an object of the present inventive concepts to provide a device that projects a small point of light on a distal surface in an erratic manner to provide a source of attraction and entertainment to an animal.

It is a further object of the present inventive concepts to provide a lighted toy that is attachable to a support surface, such as a ceiling or a wall.

It is a further object of the present inventive concepts to provide a lighted toy with rotational and pivotal structures that are capable of providing a moving point of light.

It is a still further object of the present inventive concepts to provide a lighted toy which is capable of displaying a light object in either a constant or intermittent manner.

It is a still further object of the present inventive concepts to provide a lighted toy which deactivates after a pre-determined period of operation.

According to an embodiment incorporating principles of the present inventive concepts, a pet toy preferably includes a laser or other light source and is constructed and adapted to direct a point of light on a distal surface to provide entertainment to a pet. The pet toy preferably includes a housing having a main housing with a top surface and one or more secondary housing components providing a bottom. An attachment mechanism can be provided on the top surface of the housing to attach the housing to a support surface, such as a ceiling or a wall.

The laser or other light source can be contained within or mounted to the housing and can be arranged to direct its light away from the bottom of the housing. The bottom of the housing can be further constructed and adapted to provide rotational movement of the laser/light source. The laser/light source can also be capable of pivotal movement with respect to the housing bottom, which in combination with rotational movement can provide the ability to direct the light object onto a distal surface anywhere within a predefined circular area.

One or more motors can be contained within the housing to drive the rotational and pivotal movements of the laser/light source through, for instance, geared interactions. A power source, such as a battery, may also be contained within the housing. A controller or control circuit can include electronic circuitry, which may be operable, for instance, from the exterior of the housing, to control the laser/light source and motor(s) in an automated or user-controlled manner. The circuitry can be configured to provide either a constant beam of light or an intermittent beam of light. Further optionally, the circuitry can include a timing mechanism to deactivate the laser/light source after a predetermined period of operation.

The controller may be operable through a remote control unit that has a signal transmitter that communicates with a signal receiver contained within the housing. The remote control unit may be configured to control one or more operations of the pet toy, including, for instance, an on/off function of the laser/light source, operation of the motor(s) to control movement of the light source, and other operating features of the laser/light source (i.e., selection between a constant or intermittent light display).

Various aspects, embodiments, and configurations of the inventive concepts are possible without departing from the principles disclosed herein. The inventive concepts are therefore not limited to any of the particular aspects, embodiments, or configurations described herein.

### BRIEF DESCRIPTION OF DRAWINGS

The foregoing and additional objects, features, and advantages of the present inventive concepts will become more readily apparent from the following detailed description of preferred embodiments, made with reference to the accompanying drawings, in which:

FIG. 1 is a somewhat schematic perspective view of a pet toy according to various principles of the present inventive concepts;

FIG. 1A is a somewhat schematic perspective view of the pet toy of FIG. 1, illustrating movement capabilities of to the laser/light source;

FIG. 1B is a somewhat schematic perspective view of the pet toy of FIG. 1, illustrating an embodiment in which the pet toy is operable through a remote control unit according to additional principles of the present inventive concepts;

FIG. 2A is a somewhat schematic perspective view illustrating operation of the pet toy of FIG. 1, wherein a light object is projected on a distal surface to entertain a cat;

FIG. 2B is a somewhat schematic perspective view illustrating operation of the pet toy of FIG. 1, wherein a light object is projected on a distal surface to entertain a dog;

FIG. 3A is a somewhat schematic perspective view of the pet toy of FIG. 1, illustrating mounting of the pet toy on a ceiling surface according to principles of the present inventive concepts;

FIG. 3B is a somewhat schematic perspective view of the pet toy of FIG. 1, illustrating mounting of the pet toy on a wall surface according to additional principles of the present inventive concepts;

FIG. 4 is a somewhat schematic exploded perspective view of the pet toy of FIG. 1, illustrating the various components of the pet toy according to one embodiment incorporating principles of the present inventive concepts;

FIG. 5 is a somewhat transparent schematic perspective view of a main housing of the pet toy of FIG. 1;

FIG. 6 is a somewhat transparent schematic perspective view of a secondary housing unit of the pet toy of FIG. 1;

FIG. 7 is a somewhat transparent schematic perspective view of a light emitting diode (LED) plate attachable to a bottom of the housing of the pet toy of FIG. 1;

FIG. 8 is a somewhat transparent schematic perspective view of a turret housing for providing a bottom portion of the housing of the pet toy of FIG. 1;

FIGS. 9A and 9B are somewhat transparent schematic right and front side views, respectively, of the turret housing of the pet toy of FIG. 1;

FIG. 10 is a somewhat transparent schematic perspective view of a turret gear for providing turret movement for the pet toy of FIG. 1, according to still further aspects of the present inventive concepts;

FIG. 11 is a somewhat transparent schematic perspective view of a laser/light source mount for mounting the laser/light source in a rotatable relationship with respect to the turret housing of the pet toy of FIG. 1, according to still other aspects of the present inventive concepts;

FIG. 12 is a somewhat schematic perspective view of a laser for providing a light source of the pet toy of FIG. 1, according to aspects of the present inventive concepts;

FIGS. 13A-13B are somewhat transparent schematic perspective views of top and bottom portions, respectively, of a gear box for the pet toy of FIG. 1, according to further aspects of the present inventive concepts;

FIG. 13C is a somewhat schematic perspective view of a motor for driving movement of the various components of the pet toy of FIG. 1;

FIGS. 14A-14D are somewhat transparent schematic perspective views of various gears for driving movement of the turret and rotatable laser mount of the pet toy of FIG. 1, according to still further aspects of the present inventive concepts;

FIGS. 15A-15C are somewhat transparent schematic perspective views of various electronic components of the pet toy of FIG. 1;

FIG. 16 is a somewhat transparent schematic perspective view of a mounting structure for mounting the pet toy of FIG. 1 on a wall or ceiling surface according to an alternative embodiment; and

FIGS. 17A-17C are somewhat transparent schematic perspective views of components of a remote control unit for remotely controlling operation of the pet toy of FIG. 1, according to still further aspects of the present inventive concepts.

### DETAILED DESCRIPTION OF THE INVENTIVE CONCEPTS

Various features, benefits, and configurations of the present inventive concepts are shown in the accompanying drawings in illustrative embodiments. Additional features, benefits and configurations will be readily apparent to those of ordinary skill in the art based on this disclosure, and all such features, benefits and configurations are within the scope of the present inventive concepts. Various embodiments will now be described in detail with reference to the accompanying drawings.

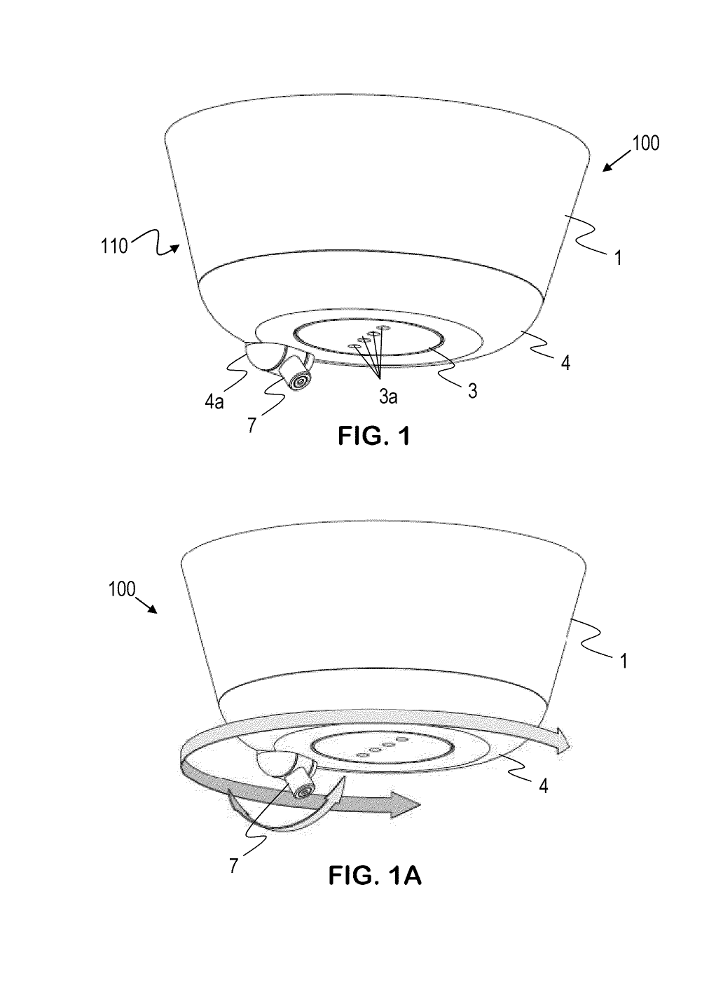

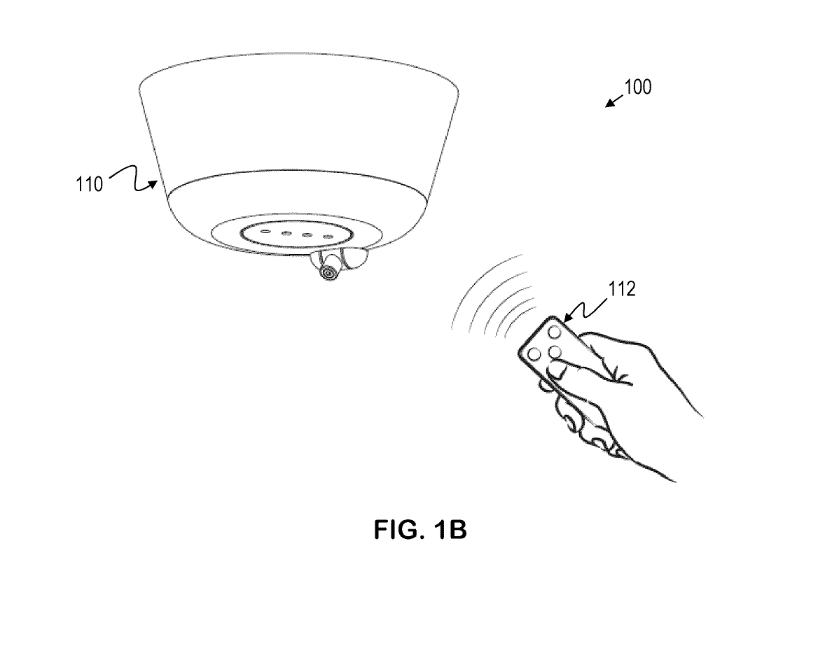

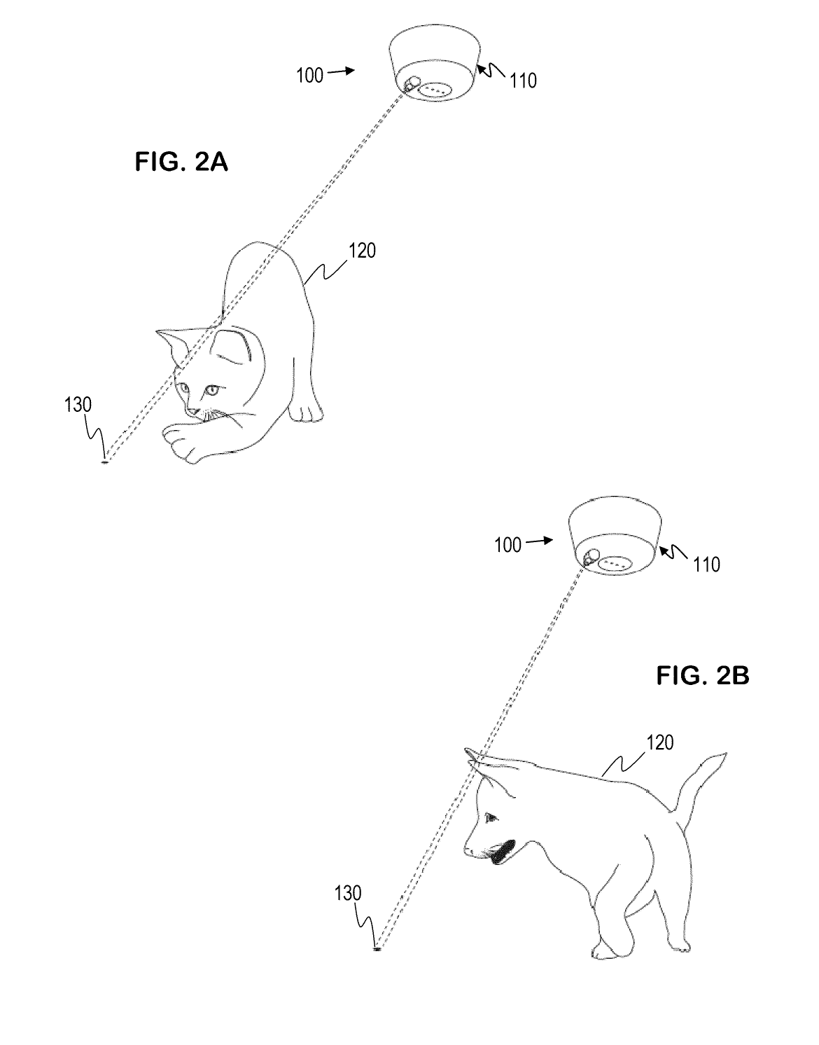

FIG. 1 is a somewhat schematic perspective view of a pet toy 100 according to various principles of the present inventive concepts. FIG. 1A is a somewhat schematic perspective view of the pet toy 100 of FIG. 1, illustrating movement capabilities of the turret 4 and attached laser/light source 7 according to a preferred aspect of the inventive concepts. FIG. 1B is a somewhat schematic perspective view of an embodiment of the pet toy 100 of FIG. 1, in which the pet toy 100 is operable through a remote control unit 112. FIGS. 2A and 2B are somewhat schematic perspective views illustrating operation of the pet toy 100 of FIG. 1, wherein a light object 130 is projected on a distal surface to entertain a pet (i.e., a cat or dog) 120.

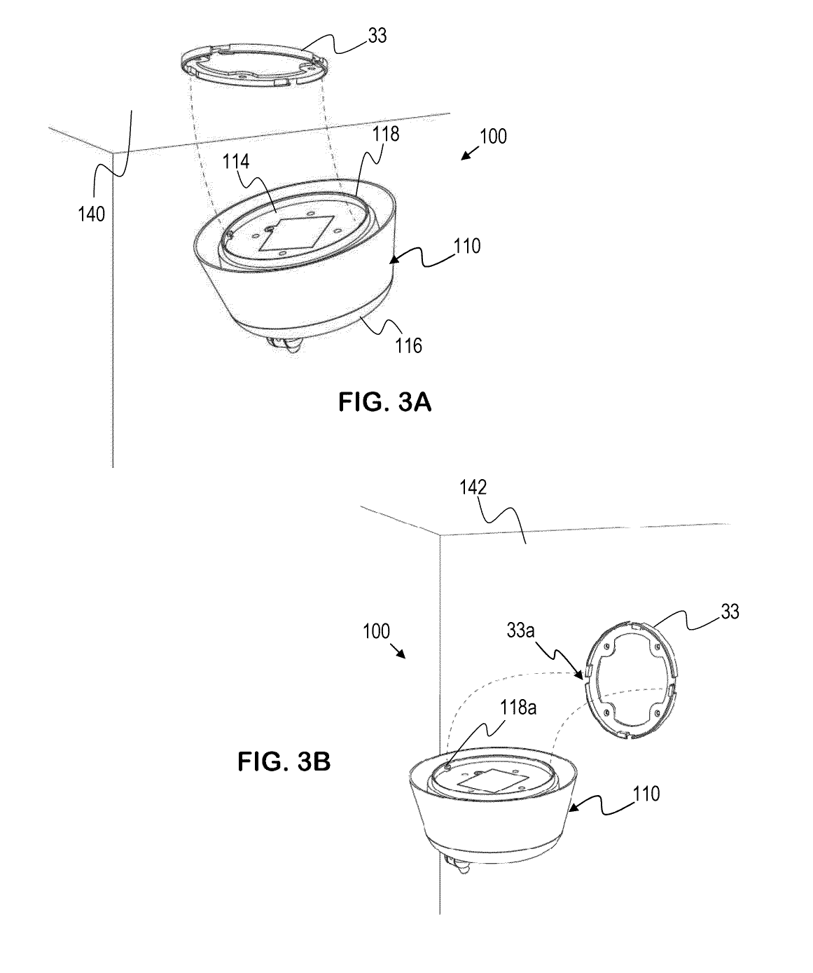

FIG. 3A is a somewhat schematic perspective view of the pet toy 100 of FIG. 1, illustrating a structure 33 for mounting the pet toy 100 on a ceiling surface 140 according to principles of the present inventive concepts. And FIG. 3B is a somewhat schematic perspective view of the pet toy of FIG. 1, illustrating a structure 33 for mounting the pet toy 100 on a wall surface 142 according to additional principles of the inventive concepts.

Referring now to FIGS. 1-3B, a pet toy 100 constructed according to principles of the inventive concepts preferably comprises a housing 110. The housing 110 can include multiple housing members, including a main housing unit 1. A secondary housing member, such as a turret 4, can be provided and arranged at a bottom of the housing 110. The turret 4 is preferably capable of rotational movement with respect to the main housing unit 1. The turret 4 can, for example, be a ring that extends around a periphery at the bottom of the housing 110, and is preferably capable of 360° rotational movement.

A stationary central housing member 3 can also be provided at the bottom of the housing 110 at the center of the turret ring 4. The central housing portion 3 can include a secondary light source 3a, such as one or more light emitting diodes (LEDs) 3a, for example. The secondary light source 3a can be positioned to direct its light away from the bottom of the housing 110. When the pet toy 100 is ceiling mounted, for instance, the secondary light source 3a may be configured to shine light in a vertically downward direction.

A laser or other light source 8 can be attached to the turret 4 at the bottom of the housing 110. The laser/light source 8 is preferably attached to the turret 4 via a pivot member 7 that is pivotally arranged in a pivot mount 4a, to allow pivoting movement of the laser/light source 8 along a plane substantially transverse to a bottom surface of the housing 110.

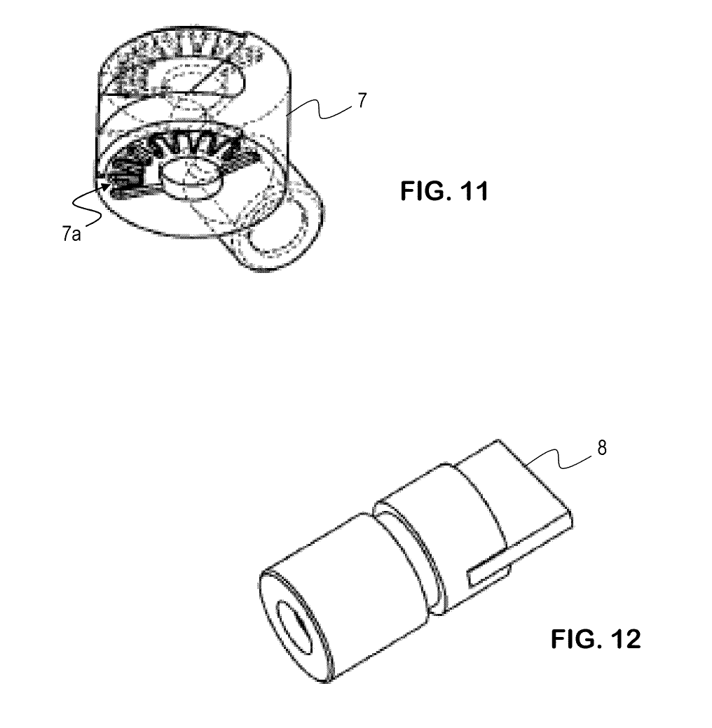

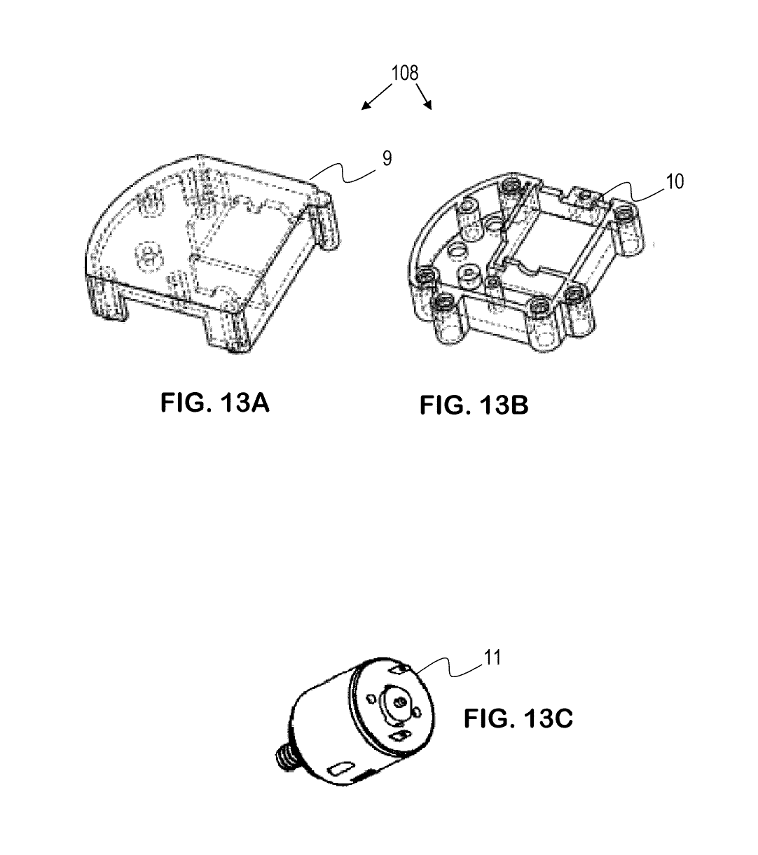

One or more motors can be provided within the housing 110 to drive rotational movement of the turret 4 and pivotal movement of the pivot member 7. For example, a first motor means 11 (see FIG. 13C) can be arranged within the housing 110 to control rotational movement of the turret 4. A second motor means (not shown) can also be arranged within the housing 110 to control pivotal movement of the pivot member 7 and attached laser/light source 8. Alternatively, a single motor can be used to control both rotational movement of the turret 4 and pivot movement of the pivot member 7.

The housing 110 can include top and bottom surfaces 114, 116, respectively. An attachment mechanism 118 can be provided on the top surface 114 to allow the toy 100 to be secured to a substantially flat support surface, such as a ceiling 140 or a wall 142. For instance, a wall or ceiling attachment plate 33 can be first secured to the desired surface 140, 142 through an appropriate attachment mechanism (e.g., adhesive, screws, nails, or other appropriate attachment device). In the embodiments shown in FIGS. 3A and 3B, for instance, screws or nails can be inserted through holes in the attachment plate 33 to secure it to the ceiling or wall surface. Alternatively, as shown in FIG. 16, the attachment plate 33 can include a rearward surface 33b to which an adhesive can be applied to secure the attachment plate 33 to the ceiling 140 or wall 142. The housing 110 can then be attached to the attachment plate 33 by aligning protrusions 118a on the attachment mechanism 118 with receptacles 33a in the attachment plate 33 and then rotating the housing 110 to secure it onto the attachment plate 33.

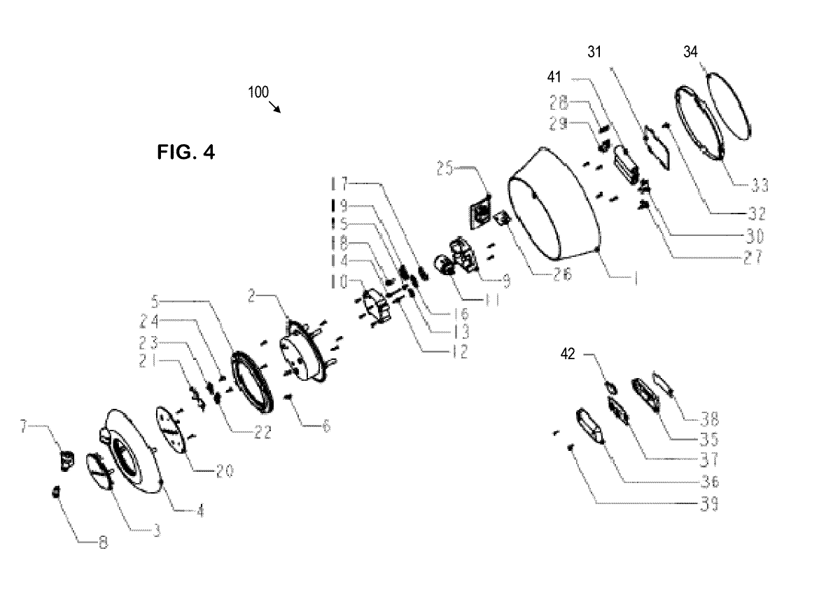

FIG. 4 is a somewhat schematic exploded perspective view of the pet toy 100 of FIG. 1, illustrating the various components of the pet toy 100 according to principles of the present inventive concepts.

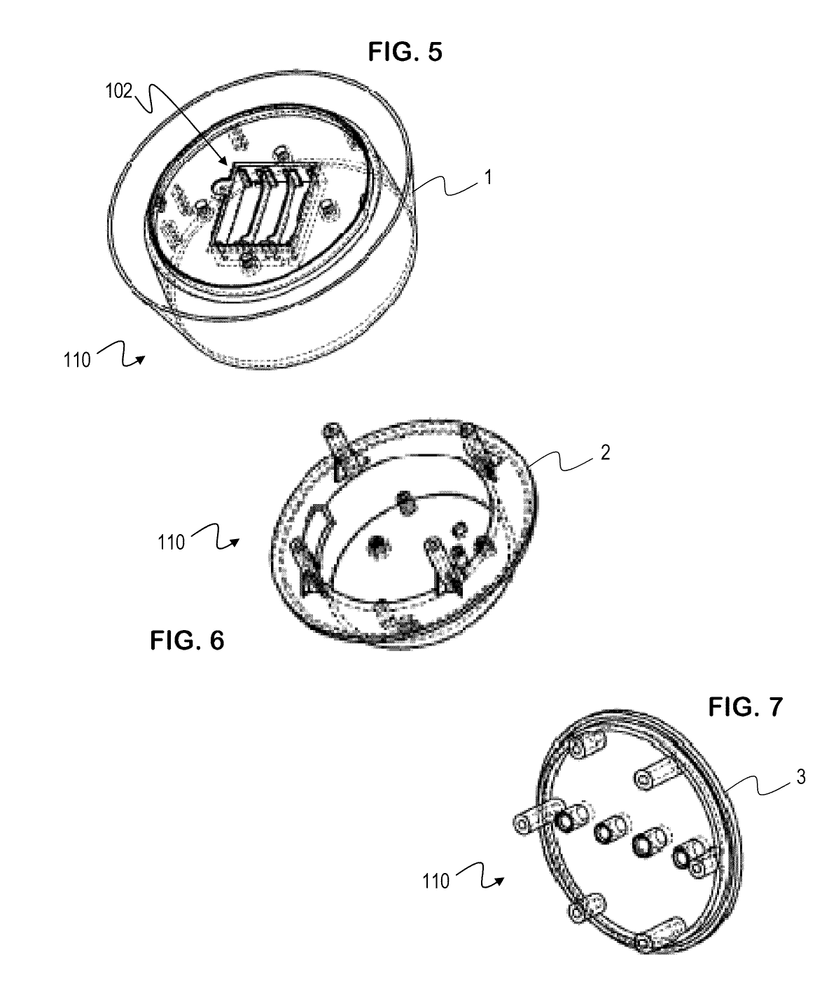

Referring additionally to FIG. 4, a power supply 41, such as one or more batteries, can be located in a battery compartment 102 (see FIG. 5) contained within the housing 110 and can be configured to provide power to various electronic components of the pet toy 100. The electronic components can, for instance, include electronic circuitry (such as one or more circuit boards 25, 26, 20) arranged in electronic communication with the power means 41, the laser/light source 8, the secondary light source 3a, and the motor(s) 11.

The electronic circuitry 25, 26 can control the delivery of power from the power source 41 to the laser/light source 8 and the motor(s) 11 based on user control or an automated function programmed into the circuitry. Preferably, the electronic circuitry 25, 26 can be configured to permit the selective display of either a constant beam of light or an intermittent beam of light from the pet toy 100. The electronic circuitry 25, 26 can further comprise a timing mechanism configured to deactivate the laser/light source 8 after a pre-determined period of operation.

Additional features of the pet toy 100 according to a preferred embodiment will now be described with reference to FIGS. 4-12. FIG. 5 is a somewhat transparent perspective view of a main housing 1 of the pet toy 100 of FIG. 1. FIG. 6 is a somewhat transparent perspective view of a secondary housing unit 2 of the pet toy 100 of FIG. 1. FIG. 7 is a somewhat transparent perspective view of a light emitting diode (LED) plate 3 attachable to a bottom of the housing 110 of the pet toy 100 of FIG. 1.

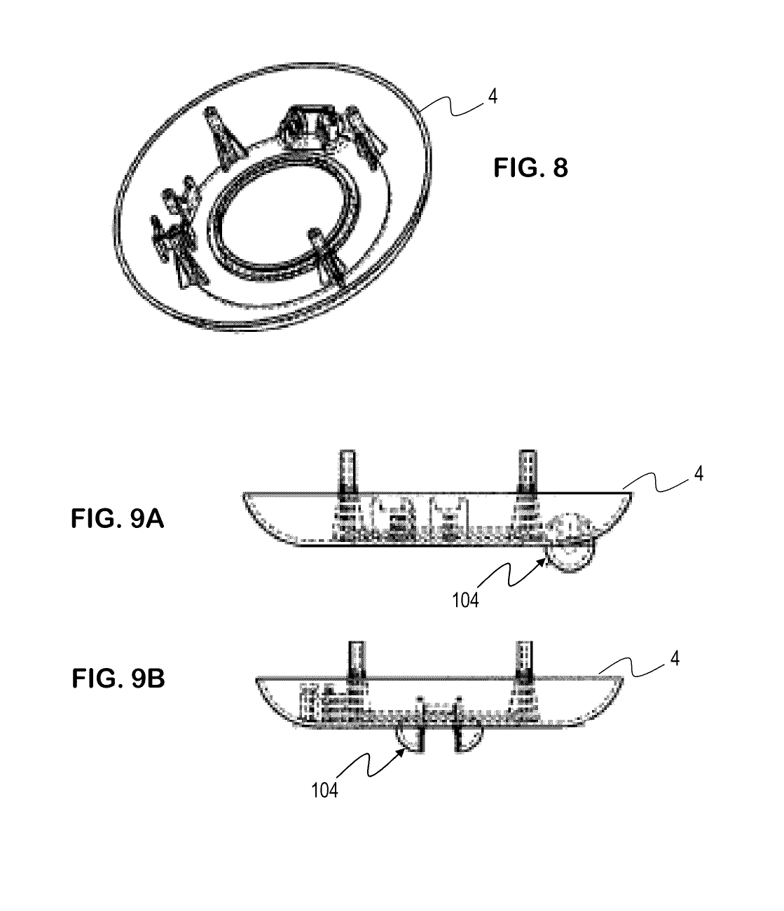

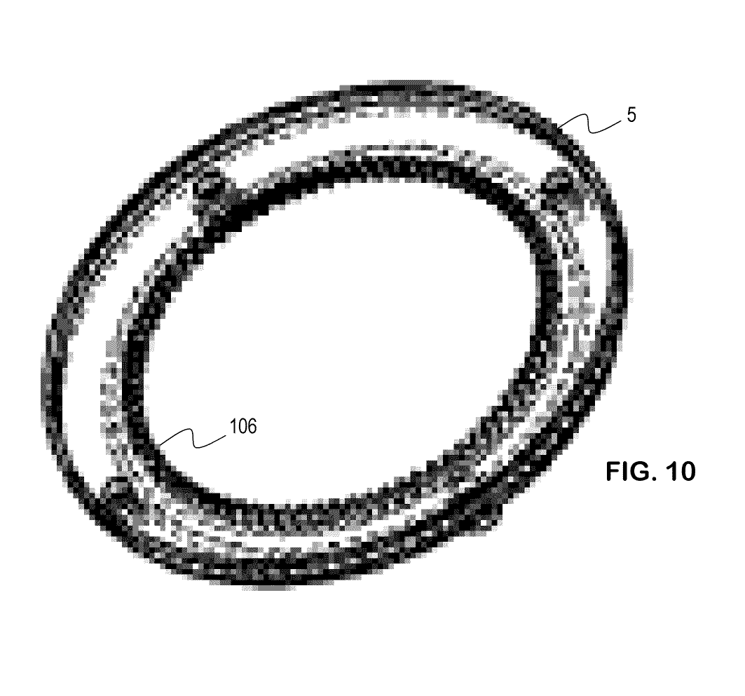

FIG. 8 is a somewhat transparent perspective view of a turret housing 4 for providing a rotatable bottom portion of the housing 110 of the pet toy 100 of FIG. 1. FIGS. 9A and 9B are somewhat transparent right and front side views of the turret housing 4 of the pet toy 100 of FIG. 1. FIG. 10 is a somewhat transparent perspective view of a turret gear 5 for providing turret movement for the pet toy 100 of FIG. 1, according to still further aspects of the present inventive concepts. FIG. 11 is a somewhat transparent perspective view of a laser mount 7 for mounting the laser/light source 8 in a pivotal relationship with respect to the turret housing 4 of the pet toy of FIG. 1. FIG. 12 is a somewhat schematic perspective view of a laser for providing a light source 8 of the pet toy of FIG. 1, according to aspects of the present inventive concepts.

As shown in FIGS. 4-7, the housing 110 can include a main housing 1 along with secondary housing members 2, 3. A secondary housing member 2 can be connected to the main housing 1 and provide a structure for mounting the turret 4 and the LED plate 3. The LED plate 3 can secure an LED board 20 to the secondary housing 2 to provide a secondary light source 3a. The main housing can include a battery compartment 102 that houses the power source 41 of the pet toy 100.

The secondary housing member 2 can fit substantially inside the main housing 1 and hold a gear box 108 constructed with top and bottom portions 9, 10, respectively (see FIGS. 13A-13B). The turret gear 5 can fit around an outside of the secondary housing 2, and can communicate with a gear driven by motor 11 in the gear box 9, 10. The turret gear 5 is, in turn, connected to the turret 4. The motor 11 can thereby drive rotation of the turret 4 under the control of the electronic circuitry 25, 26.

A pivot member 7, holding the laser/light source 8, is preferably arranged in a pivot mount 4a on the turret 4. The pivot member 7 preferably includes a geared outer surface 7a that communicates with a gear driven by the motor 11 or a second motor (not shown). The first or second motor can thereby drive the pivoting movement of the pivot member 7 under the control of the electronic circuitry 25, 26.

The laser/light source 8 illustrated is preferably a 4 mW, 650 nm laser operating at 3VDC@25 mA. However, any appropriate light source (for example, a light emitting diode, laser diode, or other light source) capable of projecting a point of light 130 (see FIG. 2A) on a distal surface may be used without deviating from the scope of the present inventive concepts.

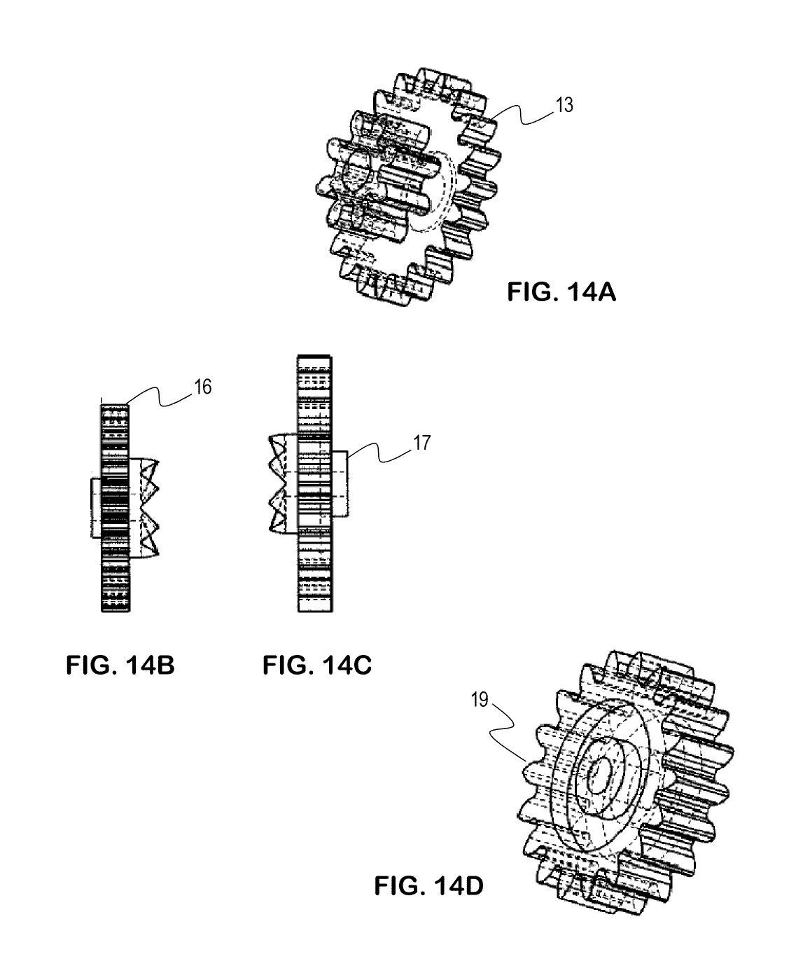

FIGS. 13A-13B are somewhat schematic transparent perspective views of top and bottom portions 9, 10, respectively, of a gear box 108 for the pet toy 100 of FIG. 1, according to further aspects of the present inventive concepts. FIG. 13C is a somewhat schematic perspective view of a motor 11 for driving movement of the various components of the pet toy 100 of FIG. 1 through geared interrelationships. FIGS. 14A-14D are somewhat schematic transparent perspective views of various gears 13, 16, 17, 19 for driving movement of the rotatable turret 4 and pivoting member 7 of the pet toy 100 of FIG. 1, according to still further aspects of the present inventive concepts.

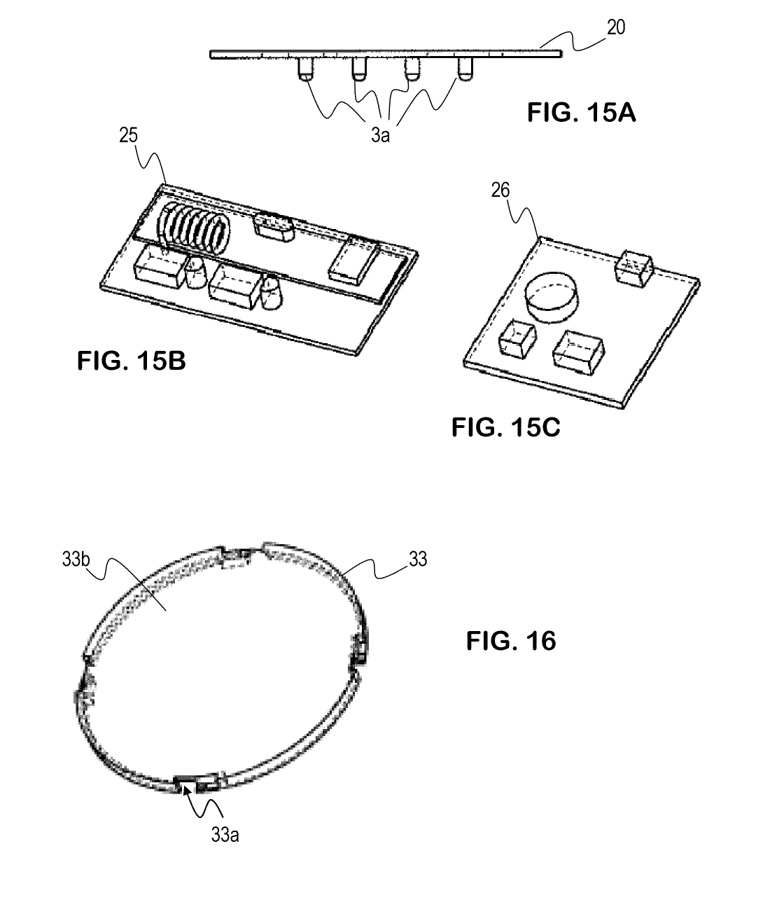

Referring to FIGS. 13A-14D, movement of the rotatable turret 4 and pivoting member 7 can be controlled by one or more motors 11 through a geared interrelationship. A gear box 108 comprising top and bottom portions 9, 10 can house the motor 11, the clutch gears 16, 17, a drive gear 13, and a spur gear 19. The gears can be configured to translate motor shaft rotation into rotational movement of the turret gear 5 and attached turret 4 and pivoting movement of the pivot member 7. The shaft rotation of the motor 11 is driven by the electronic control circuit 25, 26 (see FIGS. 15A-15C).

FIGS. 15A-15C are somewhat schematic transparent perspective views of various electronic components 20, 25, 26 of the pet toy 100 of FIG. 1. Referring to FIGS. 15A-15C, the electronic components of the pet toy 100 can include a primary circuit board 25, a secondary board 26, and an LED board 20. The primary and/or secondary circuit boards can control operation of the motor(s) to drive movement of the laser/light source 8 and can further control operation of the laser/light source 8. The LED board 20 can include a plurality of LEDs 3a (or other secondary light source) and can also be controlled by the primary and/or secondary circuit boards 25, 26. The circuit boards 25, 26 can also include a receiver to receive control signals transmitted from a remote control unit 112.

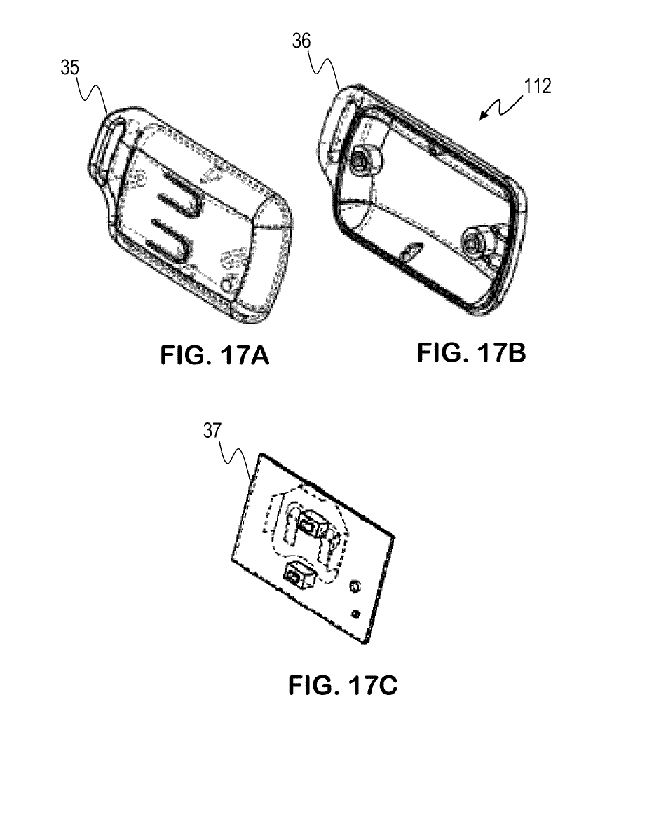

FIGS. 17A-17C are somewhat schematic transparent perspective views of components of a remote control unit 112 for remotely controlling operation of the pet toy 100 of FIG. 1, according to still further aspects of the present inventive concepts. Referring to FIGS. 1B, 4, and 17A-17C, the control circuitry of the pet toy 100 may be operable from a remote handheld mechanism or remote control unit 112. The remote control unit 112 preferably includes a wireless transmitter 37 and a power source 42. The wireless transmitter on the remote electronics board 37 preferably communicates with a wireless receiver within the housing 110. The remote control unit 112 thereby allows a user to remotely control the pet toy 100 at a distance from the pet toy 100.

The present inventive concepts have been described with reference to a preferred embodiment thereof. It should be readily apparent to those skilled in the art, however, that many changes, variations, modifications, and other uses and applications to the disclosed device are possible, and all such changes, variations, modifications, and other uses and applications which do not depart from the spirit and scope of the inventive concepts disclosed herein should be deemed to be covered by the following claims.

What is claimed is:

1. A pet toy configured to be mounted to a mounting surface, said pet toy comprising:
a housing comprising an attachment structure for attaching the pet toy to a mounting surface;
a power supply receptacle arranged in the housing and configured to hold a portable power supply;
a light source arranged on the housing and configured to project a point of light away from the housing onto a distal surface; and
an electronic circuit arranged within the housing and configured to receive power from the portable power supply and to selectively supply power from the power supply to the light source to cause the light source to project the point of light,
wherein the light source is moveably mounted to the housing such that it is capable of directing the point of light at various positions on the distal surface.

2. The pet toy of claim 1, wherein the housing comprises a turret to which the light source is mounted.

3. The pet toy of claim 2, wherein the light source is capable of rotating around an outer periphery of the housing.

4. The pet toy of claim 1, wherein the light source is pivotably connected to a bottom of the housing and is capable of pivotal movement with respect to the housing.

5. The pet toy of claim 2, wherein the light source is pivotably mounted to the turret.

6. The pet toy of claim 1, wherein the electronic circuit comprises a timing circuit configured to automatically turn off the light source after a predetermined period of operation.

7. The pet toy of claim 1, wherein operation of the pet toy is controllable through a remote control.

8. The pet toy of claim 1, further comprising a secondary light source configured to shine light away from a bottom of the housing when the secondary light source is activated.

9. The pet toy of claim 1, wherein movement of the light source is driven by a motor through a geared interaction.

10. The pet toy of claim 9, wherein the electronic circuit is configured to control operation of the motor to drive rotational movement of a turret and pivoting movement of a pivot member for moving the light source.

11. The pet toy of claim 1, wherein the electronic circuit is configured to control operation based upon automated program instructions.

12. The pet toy of claim 1, wherein the electronic circuit is operable to cause the light source to emit either a constant beam of light or an intermittent beam of light during operation.

13. The pet toy of claim 1, wherein the light source comprises a laser.

14. The pet toy of claim 1, wherein the light source comprises a light emitting diode.

15. A pet toy configured to be mounted to a mounting surface, said pet toy comprising:
a housing comprising a main housing;
an attachment structure configured to attach the main housing to the mounting surface;
a secondary housing configured to be rotatably attached to the main housing;
a pivot member arranged on the secondary housing;
a light source connected to the pivot member and configured to project a point of light onto a distal surface; and
an electronic circuit arranged within the housing and configured to receive power from the portable power supply and to selectively supply power from the power supply to the light source to cause the light source to project the point of light, said electronic circuit further configured to drive rotational movement of the secondary housing with respect to the main housing and to drive pivoting movement of the pivot member to cause the projected point of light to move.

16. The pet toy of claim 15, wherein the electronic circuit is operable to cause the light source to emit either a constant beam of light or an intermittent beam of light during operation.

17. The pet toy of claim 15, further comprising a remote control unit configured to remotely control operation of the pet toy.

18. A pet toy comprising:
a housing;
a light source arranged on the housing and configured to move with respect to said housing to project a moving point of light onto a distal surface; and
an electronic circuit arranged within the housing and configured to receive power from a power supply, said electronic circuit configured to selectively supply power to the light source to cause the light source to project the point of light and further configured to control movement of the light source with respect to said housing.

19. The pet toy of claim 18, wherein the electronic circuit is operable to cause the light source to emit either a constant beam of light or an intermittent beam of light during operation based on either random selection by the electronic circuit or user selection.

20. The pet toy of claim 18, wherein the electronic circuit is configured to control movement of the light source through one or more motors.
